(19) United States
(12) Patent Application Publication
(10) Pub. No.: US 2018/0180535 A1
(43) Pub. Date: Jun. 28, 2018

(54) DETERMINING ABSORPTION AND SCATTERING COEFFICIENT USING A CALIBRATED OPTICAL REFLECTANCE SIGNAL

(71) Applicant: COMMISSARIAT A L'ENERGIE ATOMIQUE ET AUX ENERGIES ALTERNATIVES, Paris (FR)

(72) Inventors: Veronica SORGATO, Grenoble (FR); Anne PLANAT-CHRETIEN, St Egreve (FR); Michel BERGER, Cossey Claix (FR)

(73) Assignee: COMMISSARIAT A L'ENERGIE ATOMIQUE ET AUX ENERGIES ALTERNATIVES, Paris (FR)

(21) Appl. No.: 15/737,600

(22) PCT Filed: Jun. 20, 2016
(86) PCT No.: PCT/FR2016/051501

§ 371 Date: Dec. 18, 2017

(30) Foreign Application Priority Data
Jun. 19, 2015 (FR) 1555657

(51) Int. Cl. G01N 21/27; G01N 21/49

(52) U.S. Cl. CPC G01N 21/274; G01N 2021/4735; G01N 21/49

(57) ABSTRACT

A technique of optical scatter measurement of a sample, and analysis of a signal representative of radiation back-scattered by a sample illuminated by a light beam. The analysis determines optical properties of the sample. A method implemented is an iterative method for applying, to the analyzed signal, a calibration factor taking optical properties of the sample into consideration.

### TECHNICAL FIELD

The invention lies in the field of the characterization of samples, and in particular biological samples, and more particularly the skin.

### DESCRIPTION OF THE PRIOR ART

Optical measurements, used to characterize the optical properties of samples, are widespread. The measurements based on the detection of a signal backscattered by a sample illuminated by a light beam can in particular be cited. These are in particular Raman spectroscopy, fluorescent imaging or reflectance spectrometry.

Diffuse reflectance spectroscopy consists in exploiting the light backscattered by a scattering object subjected to a lighting, generally spotlighting. This technique proves powerful for characterizing surface optical properties of samples, in particular the scattering or absorption properties.

When implemented on the skin, this technique for example makes it possible to characterize the dermis or the epidermis, as described in the document EP 2762064. This document describes a measurement probe intended to be applied against the skin. This probe comprises a central optical fiber, called emission fiber, linked to a light source, and intended to direct a light beam toward a skin sample. Optical fibers, arranged around the central fiber, called detection fibers, collect an optical signal backscattered by the dermis, this optical signal being then detected by a photodetector. Means for spectral analysis of the optical signal, coupled to computation algorithms, make it possible to estimate parameters of the dermis, in particular the concentration of certain chromophores, for example oxyhemoglobin or deoxyhemoglobin and/or optical properties governing the paths of photons in the dermis, in particular the reduced scattering coefficient μₛ′ as well as the absorption coefficient μₐ.

Thus, the probe comprises an illumination line, intended to illuminate the sample, comprising the light source and the emission optical fiber. The probe also comprises a detection line, intended to detect a light backscattered by the sample, comprising the detection optical fibers and the photodetector. The properties of the illumination line and of the detection line are taken into account by virtue of a calibration step, allowing the calibration factor to be determined. The latter is obtained by performing a measurement on a calibration sample, whose optical properties are known. This calibration factor, denoted by the term M^{std} in this application, is then applied to the signal measured by the photodetector, denoted by the term M^{skin}.

The document by Qin J, “Hyperspectral diffuse reflectance imaging for rapid, none contact measurement of the optical properties of turbid materials” Applied Optics vol. 45 No. 32, 10 Nov. 2006, describes a method for determining optical properties by diffuse reflectance spectrometry. This method comprises a detection, by a spectrometric photodetector, of a radiation backscattered by a sample to several backscattering distances. The signal thus detected is multiplied by a calibration factor. The estimation of the optical properties is performed by an adjustment using a scattering model representing the trend of the reduced scattering coefficient in the calibration sample. Thus, the determination of the optical properties is based on an a priori knowledge of the sample and of a model of scattering of the light in the sample analyzed, this model describing the trend of the value of the scattering coefficient as a function of the wavelength. The determination of the optical properties is quantitative only for an analyzed sample whose scattering coefficient reduces the same model as the calibration samples. It is understood that the need to be based on a model constitutes a restrictive limitation. Such a method is not suitable for a complex sample, for which the a priori scattering model is not known. Moreover, the taking into account of this model means that different estimations of an optical property, at different wavelengths, are not independent of one another, since they are linked by the model.

The inventors have observed that the methods cited previously are not optimal. One objective of the present invention is to improve the prior art methods, so as to determine the optical properties of a sample with increased accuracy.

### SUMMARY OF THE INVENTION

One object of the invention is a method for determining an optical property of a sample, comprising the following steps:
i) illumination of a surface of the sample, using a light beam produced by a light source, so as to form, on the surface of said sample, an elementary illumination zone, corresponding to the part of said surface lit by said beam;
ii) acquisition, using a photodetector, of a backscattering signal, representative of a radiation backscattered, by the sample, at a distance, called backscattering distance, from said elementary illumination zone;
iii) selection of a calibration factor;
iv) application of said calibration factor to each backscattering signal, so as to obtain a quantity of interest, associated with said backscattering distance;
v) repetition of the steps iv) to v), by updating the calibration factor, as a function of said thus determined optical property, until a stop criterion or a predetermined number of iterations is reached;

The steps iv) to vi) can be repeated until a stop criterion or a predetermined number of iterations is reached.

According to an embodiment, at least one calibration factor is a measured calibration factor, by effecting a ratio between:
an estimation of a quantity representative of a backscattered radiation emanating from a surface of a calibration sample, to a backscattering distance from an elementary illumination zone of said calibration sample, when the calibration sample is illuminated by said light beam;
a measurement of said quantity, using a backscattering signal detected by said photodetector, the calibration sample being illuminated by said light beam.

A calibration factor can be determined by interpolation from two measured calibration factors, said measured calibration factors being obtained by using, respectively, two calibration samples whose optical properties are different.

According to an embodiment, in the step vi), the calibration factor can be replaced by a calibration factor determined as a function of the optical property defined in the step v) preceding said step vi). This optical property, considered for the updating of the calibration factor, can in particular be a scattering optical property. It can for example be a scattering coefficient or a reduced scattering coefficient.

The method can comprise at least one of the following features, taken alone or in all technically feasible combinations:
the step iv) comprises the application of a refresh factor, corresponding to the backscattering distance, to each calibration factor, the refresh factor having been previously determined, by:
   measuring, at an instant t, a backscattering signal, representing a backscattered radiation emanating from the surface of a calibration sample, to a backscattering distance from an elementary illumination zone of said calibration sample, the calibration sample being illuminated by said light beam;
   comparing said backscattering signal measured at the instant t to a signal measured, in the same conditions, at an instant t₀, prior to the instant t.
In the step v), the determination of said optical property comprises a comparison between:
   a quantity of interest,
   a plurality of estimations of said quantity of interest, each estimation being performed by considering a predetermined value of said optical property.
Each backscattering signal is acquired at a plurality of wavelengths, such that the quantity of interest and the calibration factor can take the form of spectral functions, defined over said plurality of wavelengths.
The quantity of interest, associated with a backscattering distance, is obtained by the application of a ratio between the intensity of a backscattering signal, corresponding to said backscattering distance, by the intensity of said light beam, measured by the photodetector, in which case said quantity of interest is a reflectance.
In the step v), different values of said quantity of interest are considered, each value corresponding to a different backscattering distance.
The sample examined is a human, animal or plant tissue, or a food product.

Another object of the invention is an information storage medium, that can be read by a processor, comprising instructions for the execution of a method described above, these instructions being able to be executed by a processor.

Another object of the invention is a device for measuring an optical signal produced by a sample comprising:
a light source capable of emitting a light beam toward a surface of said sample, so as to form, on said surface, an elementary illumination zone
a photodetector capable of acquiring a backscattering signal, representative of a radiation backscattered by the sample at a distance, called backscattering distance, from said elementary illumination zone;
   the device being characterized in that it also comprises:
a processor, capable of implementing the method described above.

This device can in particular comprise an optical system, configured to ensure an optical coupling between the photodetector and an elementary detection zone situated on the surface of the sample, from which backscattered radiation emanates.

### FIGURES

FIG. 1 represents a device allowing the application of the invention.

FIG. 2 is a cross-sectional view of this device, along a plane at right angles to the axis Z and passing through the distal end of the detection fibers.

FIG. 3A represents a so-called “remote” measurement configuration, whereby each optical detection fiber is placed at a distance from the sample analyzed.

FIG. 3B represents a so-called “contact” measurement configuration, whereby each optical detection fiber is placed in contact with the sample analyzed.

FIG. 4A represents the main steps of a method according to the invention.

FIG. 4B represents the main steps of a variant of the method represented in FIG. 4A.

FIG. 5 represents different calibration factors for three wavelengths (λ=470 nm, λ=607 nm and λ=741 nm), and for three different calibration samples, each calibration factor having a reduced scattering coefficient μₛ′ differing from one another.

FIG. 6 represents a modeling of the reflectance, at a given backscattering distance, for different values of the absorption coefficient μₐ and of the reduced scattering coefficient μₛ′.

FIGS. 7A, 7B, 7C and 7D represent the results of experimental tests, showing the influence of the choice of the calibration factor on the estimation of the reduced scattering coefficient (FIGS. 7A and 7C) or of the absorption coefficient (FIG. 7B and FIG. 7D).

FIGS. 8A, 8B, 8C and 8D represent the results of comparative experimental tests, showing the influence of the implementation of a method according to the invention on the estimation of the reduced scattering coefficient (FIGS. 8A and 8C) or of the absorption coefficient (FIG. 8B and FIG. 8D), according to a so-called contact measurement configuration, schematically represented in FIG. 3B.

FIGS. 9A, 9B, 9C and 9D represent the results of comparative experimental tests, showing the influence of the implementation of a method according to the invention on the estimation of the reduced scattering coefficient (FIGS. 9A and 9C) or of the absorption coefficient (FIG. 9B and FIG. 9D), according to a so-called remote measurement configuration, schematically represented in FIG. 3A.

### EXPLANATION OF PARTICULAR EMBODIMENTS

FIG. 1 represents a first embodiment of a device 1 according to the invention. It comprises a light source 10 which, in this example, is a white light source marketed by Ocean Optics under the reference HL2000.

The light source 10 comprises, in this example, an emission optical fiber 12, extending between a proximal end 14 and a distal end 16. The emission optical fiber 12 is capable of collecting the light by a proximal end 14 and of emitting a light beam 20 toward the sample by a distal end 16, said light beam being then directed toward the surface of a sample 50. In such a configuration, the light source 10 is said to be fibered.

The diameter of the emission optical fiber 12 lies between 100 μm and 1 mm, and is for example equal to 500 μm.

The device also comprises a plurality of detection optical fibers 22₁, 22₂, 22₃, . . . 22_{f} . . . 22_{F}, the index f lying between 1 and F, F denoting the number of detection optical fibers in the device. F is a natural integer generally lying between 1 and 100, and preferentially lying between 5 and 50. Each detection fiber 22₁, 22₂, 22₃, . . . 22_{f} . . . 22_{F} extends between a proximal end 24₁, 24₂, 24₃, . . . 24_{f} . . . 24_{F} and a distal end 26₁, 26₂, . . . 26_{f} . . . 26_{F}. In FIG. 1, the references 22, 24 and 26 respectively denote all of the detection fibers, all of the proximal ends of the detection fibers and all of the distal ends of the detection fibers. The diameter of each detection optical fiber 22 lies between 50 μm and 1 mm, and is for example equal to 100 μm. The proximal end 24 of each detection optical fiber 22 can be optically coupled to a photodetector 40. The distal end 26₁, 26₂, . . . 26_{F} of each detection optical fiber 22 is capable of collecting, respectively, a radiation 52₁, 52₂, . . . 52_{F} backscattered by the sample 50, when the latter is exposed to the light beam 20.

The photodetector 40 is capable of detecting each backscattered radiation 52₁, 52₂, . . . 52_{F} so as to form a signal, called backscattering signal (S₁, S₂, . . . S_{N}) as described herein below. The photodetector 40 can be a spectrally unresolved photodetector, for example a photodiode or a matrix photodetector of CCD or CMOS type. In this example, it is a spectrophotometer, capable of establishing the wavelength spectrum of the radiation collected by a detection optical fiber 22 to which it is coupled. The person skilled in the art will choose a spectrometric photodetector when he or she is prioritizing a good spectral resolution or a matrix photodetector when prioritizing a spatial resolution.

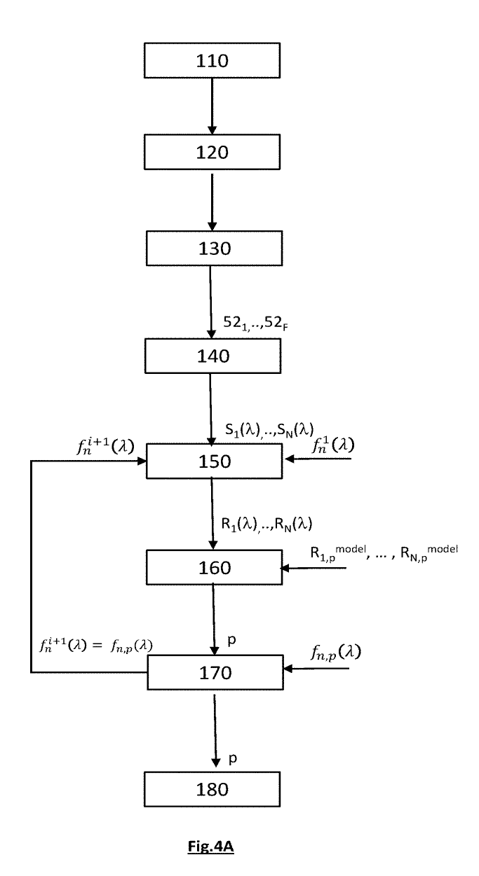

The photodetector 40 can be connected to a processor 48, the latter being linked to a memory 49 comprising instructions, the latter being able to be executed by the processor 48, to implement the method represented in FIG. 4A or 4B, and described herein below. These instructions can be saved on a storage medium, that can be read by a processor, of hard disk or CDROM type or other memory type.

The detection optical fibers 22 extend parallel to one another, parallel to a longitudinal axis Z about the emission optical fiber 12. They are held fixed relative to one another by a holding element 42. Their distal ends 26 are coplanar, and define, in this example, a detection plane 44.

An optical fiber 13, called excitation return fiber, links the light source 10 to the photodetector 40. This optical fiber is useful for performing a measurement S_{source} representing the intensity of the source, detailed later.

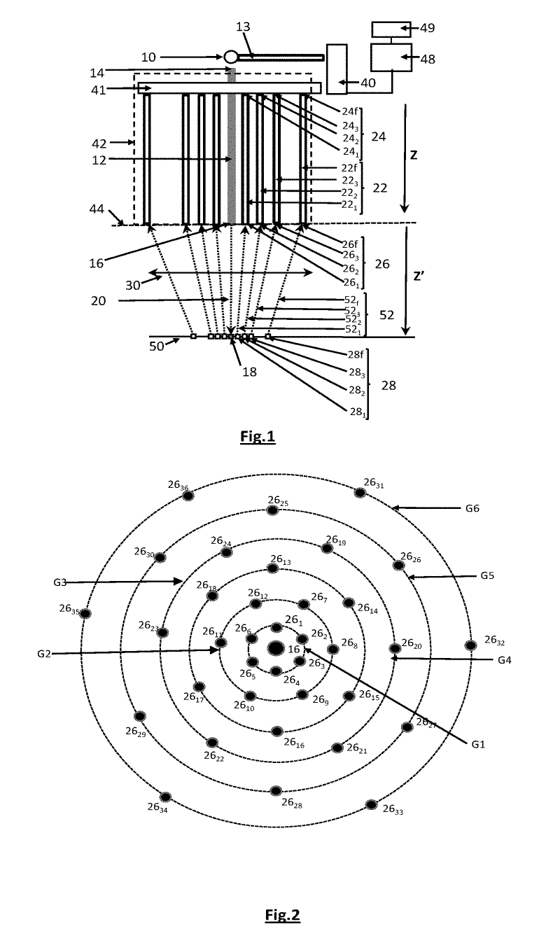

FIG. 2 represents a cross-sectional view of the device, in the detection plane 44, formed by all of the distal ends 26 of the F detection fibers. In this example, F is equal to 36. As can be seen, the detection optical fibers are distributed according to:
a first group G₁ of six detection optical fibers 22₁ . . . 22₆ arranged regularly along a circle centered on the emission optical fiber 12, such that the distal end 26₁ . . . 26₆ of each fiber of this group is distant from the distal end 16 of the emission optical fiber 12 by a first distance d₁ equal to 300 μm;
a second group G₂ of six detection optical fibers 22₇ . . . 22₁₂, arranged regularly along a circle centered on the emission optical fiber 12, such that the distal end 26₇ . . . 26₁₂ of each fiber of this group is distant from the distal end 16 of the emission optical fiber 12 by a second distance d₂ equal to 700 μm;
a third group G₃ of six detection optical fibers 22₁₃ . . . 22₁₈, arranged regularly along a circle centered on the emission optical fiber 12, such that the distal end 26₁₃ . . . 26₁₈ of each fiber of this group is distant from the distal end 16 of the emission optical fiber 12 by a third distance d₃ equal to 1.1 mm;
a fourth group G₄ of six detection optical fibers 22₁₉ . . . 22₂₄, arranged regularly along a circle centered on the emission optical fiber 12, such that the distal end 26₁₉ . . . 26₂₄ of each fibre of this group is distant from the distal end 16 of the emission optical fiber 12 by a fourth distance d₄ equal to 1.5 mm;
a fifth group G₅ of six detection optical fibers 22₂₅ . . . 25₃₀, arranged regularly along a circle centered on the emission optical fiber 12, such that the distal end 26₂₅ . . . 26₃₀ of each fiber of this group is distant from the distal end 16 of the emission optical fiber 12 by a fifth distance d₅ equal to 2 mm;
a sixth group G₆ of six detection optical fibers 22₃₁ . . . 22₃₆, arranged regularly along a circle centered on the emission optical fiber 12, such that the distal end 26₃₁ . . . 26₃₆ of each fiber of this group is distant from the distal end 16 of the emission optical fiber 12 by a sixth distance d₆ equal to 2.5 μm.

When describing a distance between two fibers, or between a fiber or a light beam, a center-to-center distance is understood.

Thus, each distal end 26_{f} of a detection optical fiber 22_{f} is placed, in a plane at right angles to the longitudinal axis Z according to which these fibers extend, at a distance d_{f} from the light source 10 (that is to say from the distal end 16 of the emission fiber 12), and, consequently, at a distance d_{f} from the light beam 20 directed toward the sample 50.

According to a variant, the distal ends 26_{f} of each detection optical fiber define a curved surface, that is adapted for example to the curvature of the surface of the sample 50.

As indicated previously, the device comprises a photodetector 40, capable of being coupled to the proximal end 24_{f} of each detection optical fiber 22_{f}. In this example, the photodetector is a spectrophotometer, capable of determining the spectrum of a radiation 52₁ . . . 52_{F} backscattered by the sample when the latter is exposed to the light beam 20. For that, the proximal ends 24 of each group of detection optical fibers, described above, are grouped together and are, group by group, successively coupled to the photodetector 40 by means of an optical switch 41. In FIG. 1, the reference 52 denotes a radiation backscattered by the sample.

In this example, the device also comprises an optical system 30, exhibiting an enlargement factor G and an optical axis Z′. In this example, the optical axis Z′ coincides with the longitudinal axis Z along which the detection optical fibers extend, which constitutes a preferred configuration.

Generally, the optical system 30 allows an image of the surface of the sample 50 to be formed on the detection plane 44 formed by the distal ends 26 of each detection optical fiber 22, with a given enlargement factor G. Thus, each distal end 26₁, 26₂, 26_{F} is respectively conjugate with an elementary detection zone 28₁, 28₂ . . . 28_{E} of the surface of the sample. This way, each detection optical fiber 22₁, 22₂, 22_{F} is capable of collecting, respectively, an elementary radiation 52₁, 52₂, 52_{f} . . . 52_{F} backscattered by the sample, each elementary radiation 52₁, 52₂, . . . 52_{F} emanating from an elementary detection zone 28₁, 28₂ . . . 28_{F}, on the surface of the sample.

Thus, each of said distal ends 26₁, 26₂ . . . 26_{E} can be situated in an image focal plane of the optical system 30, and conjugate with an elementary detection zone 28₁, 28₂ . . . 28_{E} situated in the object focal plane of said optical system, on the surface of the sample.

Likewise, the distal end 16 of the emission fiber 12 is conjugate with an elementary illumination zone 18 on the surface of the sample. Generally, the elementary illumination zone constitutes the point of impact of the light beam 20 on the surface of the sample 50.

Generally, whatever the embodiment, the term elementary zone denotes a zone of delimited form on the surface of the sample. Such an elementary zone is preferably a spot zone, that is to say that its diameter or its diagonal are less than 1 cm, and preferably less than 1 mm, even less than 500 μm.

An elementary detection zone can also take an annular form, centered on the elementary illumination zone, by defining a ring or an arc of a ring, circular or polygonal. The thickness of the ring is then preferably less than 1 cm. An elementary detection zone 28 can have any form, provided that this elementary zone is delimited by an outline, and distant from an elementary illumination zone 18, the latter also being able to have any form, but delimited and distinct from an elementary detection zone 28.

An elementary illumination zone 18 is passed through by the light beam 20, propagated toward the sample 50, whereas an elementary detection zone 28_{f} is passed through by a backscattered radiation 52_{f}, this radiation being produced by the backscattering, in the sample, of the light beam 20. The optical coupling, produced by the optical system 30, allows each detection fiber 22_{f} to collect the elementary backscattered radiation 52_{f}, the latter corresponding to the backscattered radiation passing through the elementary zone 28_{f}.

The holding element 42 can ensure a rigid link between the detection optical fibers 22 and the optical system 30, so as to keep the detection plane 44, formed by the distal ends 26 of the detection optical fibers, at a fixed distance from the optical system 30.

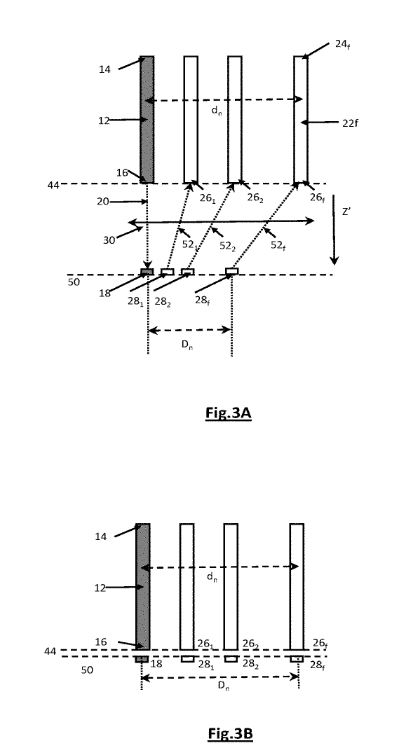

Referring to FIG. 3A, if d_{f} is the distance between the distal end 26_{f} of a detection fiber 22_{f} and the distal end 16 of the emission fiber 12, said distance calculated in a plane at right angles to the optical axis Z′, the distance D_{f} between the elementary detection zone 28_{f}, conjugate with said distal end 26_{f}, and the elementary illumination zone 18, conjugate with said distal end 16, is such that:

$${D}_{f} = \frac{{d}_{f}}{G}$$

The distance D_{f} is called backscattering distance, because it corresponds to the distance, from the elementary illumination zone 18, at which the backscattered photons are collected. That corresponds to the distance between the elementary illumination zone 18 and an elementary detection zone 28f.

Thus, as represented in FIG. 3A, the presence of the optical system 30 makes it possible to place the detection fibers 22 at a distance from the sample to be characterized, according to a so-called “remote” configuration. This distance is typically a few cm, for example between 1 and 30 cm.

According to a variant, the device is similar to that represented in FIG. 1, but it does not comprise any optical system 30. This variant corresponds to a measurement configuration called “contact” configuration. According to this variant, the detection fibers 22 are, preferably, applied directly in contact with the sample (50), by virtue of the absence of an optical system between the sample (50) and the distal end of each detection optical fiber 22. In this case, for each detection optical fiber, D_{f}=d_{f}.

Generally, each detection optical fiber 22_{f} is capable of collecting a backscattering radiation 52_{f} from an elementary detection zone 28_{f}, the latter being situated at a backscattering distance D_{f} from the elementary illumination zone 18. In this example, by virtue of the concentric arrangement of the detection fibers around the illumination fiber, described in relation to FIG. 2, the device allows N distinct backscattering distances D₁ . . . Dₙ . . . D_{N} to be defined, N being here equal to 6. Each backscattering distance Dᵣ, has a corresponding plurality of backscattered radiations, originating from different elementary detection zones. For example, the backscattering optical signals 52₁, 52₂, 52₃, 52₄, 52₅ and 52₆ correspond to the backscattering distance D₁. As previously described, the detection fibers corresponding to one and the same group, that is to say at a same backscattering distance, are coupled. Because of this, each backscattered radiation corresponding to one and the same backscattering distance Dₙ (1≤n≤6) is addressed simultaneously to the photodetector 40, the latter producing a signal Sₙ, called a backscattering signal, representative of one or more backscattered radiations at said backscattering distance Dₙ.

Whatever the configuration of the device represented in FIG. 1, contact or remote, this device comprises:
an illumination line, capable of illuminating the surface of the sample, this line comprising the light source 10 and the emission optical fiber 12;
a detection line, capable of detecting a radiation 52_{f} backscattered by the sample so as to form a backscattering signal Sₙ; this line comprises the photodetector 40 and any optical system 30 when the device is equipped therewith.

There now follows a description, in relation to FIG. 4A, of the main steps of an iterative method that can be implemented by the device previously described, in order to estimate one or more optical properties p of the sample studied. This iterative method is applied to the “contact” configuration or to the “remote” configuration previously described.

The term optical property p denotes, for example, one or more factors governing the absorption and/or the scattering of the photons in the sample studied, in particular an absorption coefficient, a scattering coefficient, a reduced scattering coefficient, a scattering anisotropy coefficient. In this example, the optical properties determined are the absorption coefficient μₐ and the reduced scattering coefficient μ′ₐ.

1^{st} step 110: application of the device previously described, facing the sample 50.

2^{nd} step 120: illumination of the sample by directing a light beam 20 against the surface of the sample, the illuminated part of the surface of the sample constituting the elementary illumination zone 18.

3^{rd} step 130: collection of a radiation 52₁, 52₂ . . . 52_{F} backscattered by the sample, emanating respectively from each elementary detection zone 28₁, 28₂, . . . 28_{F}, by the detection optical fiber 22₁, 22₂, . . . 22_{F} whose distal end 26₁, 26₂, . . . 26_{F} is respectively conjugate with said elementary zone 28₁, 28₂, 28_{F}.

4^{th} step 140: measurement, using a photodetector 40, of a backscattering signal Sₙ representative of the backscattering at each backscattering distance Dₙ. As previously indicated, the signal detected Sₙ is, in this example, established by aggregating the optical signals collected by the detection optical fibers of one and the same group Gₙ, that is to say corresponding to one and the same backscattering distance. The backscattering signal Sₙ then aggregates several backscattered radiations 52ₙ, each of them being emitted according to one and the same backscattering distance Dₙ.

When the detector is a spectrometric detector, it generates the spectrum of the signal detected Sₙ, denoted Sp(Sₙ), from which it is possible to extract spectral components Sₙ(λ) representing the signal backscattered at the distance Dₙ, and at the wavelength λ.

5^{th} step 150: using each signal Sn(λ), associated with a backscattering distance Dₙ, determination of a quantity of interest Rₙ(λ), on the basis of which the optical properties p of the samples studied will be determined. In this example, the quantity of interest Rₙ(λ) is a reflectance of the sample. Generally, the term reflectance represents the intensity of a radiation backscattered by the sample, normalized by the intensity of the incident beam on the sample. Its value depends on the wavelength λ, because of the trend of the optical properties of the scattering medium studied as a function of the wavelength.

In this example, the reflectance Rₙ(λ) depends on the backscattered signal Sn(λ) at the distance Dₙ, normalized by a quantity of light S_{source}(λ) emitted by the source, at the wavelength λ, on the time of acquisition of the backscattered signal Sₙ and on a calibration factor. The reflectance Rₙ(λ) can be defined according to the expression:

$${R}_{n} ( λ ) = \frac{{S}_{n} ( λ ) - {S}_{ref} ( λ )}{{S}_{source} ( λ ) \times t} \times {f}_{n}^{i} ( λ ) \qquad ( 1 )$$

in which:
Sₙ(λ) is the backscattering signal detected, corresponding to the backscattering distance Dₙ;
S_{ref}(λ) is a reference signal, representative of parasitic signals, such as the noise of the detector 40 or parasitic reflections from the possible optical system 30, obtained by activating the light source, but without sample, the latter being, for example, replaced by an absorbent screen of black screen type;
S_{source}(λ) is the signal produced by the light source. S_{source}(λ) can in particular be established by coupling the light source to the photodetector, for example by means of a so-called excitation return optical fiber 13, represented in FIG. 1; in this case, the photodetector acquires a signal S_{source-direct}, from which it is possible to subtract a signal S_{ref-source} representative of the noise of the detector. If t_{source} denotes the time of acquisition of the signal S_{source-direct}, S_{source} can be such that:

$${S}_{source} ( λ ) = \frac{{S}_{source \text{-} direct} ( λ ) - {S}_{ref \text{-} source} ( λ )}{{t}_{source}} .$$

fₙⁱ(λ) is a calibration factor, corresponding to the backscattering distance Dₙ and to the wavelength λ. The exponent i denotes the rank of the iteration, whereas the index n denotes the backscattering distance Dₙ. This factor takes into account the effect of different components of the illumination line and of the detection line on the backscattering signal. It involves taking account, for example, of efficiency of collection by the detection fibers 22, of the sensitivity of the photodetector 40, of the non-uniformity of the illumination beam 20 or, if necessary, of the efficiency of collection of the backscattered light by the optical system 30. This calibration factor is determined during a calibration phase. This calibration phase, implementing calibration samples, is performed before or after the measurement on the sample, and is described herein below.
t is the time of acquisition of the backscattering signal Sₙ.

The aim of the calibration phase described above is to establish a calibration factor f_{n,pcalib}(λ) by applying the device described above to a calibration sample, whose optical properties P_{calib} are known. For example, f_{n,pcalib}(λ) can be such that:

$${f}_{n , pcalib} ( λ ) = \frac{{R}_{calib \text{-} n}^{model} ( λ )}{\frac{{S}_{calib \text{-} n} ( λ ) - {S}_{ref ( λ )}}{{S}_{source} ( λ ) \times {t}_{calib}}} = \frac{{R}_{calib \text{-} n}^{model} ( λ )}{{R}_{calib \text{-} n} ( λ )} \qquad ( 2 )$$

S_{calib-n}(λ) is a backscattering signal detected, corresponding to the backscattering distance Dₙ by using the same device as that implemented to acquire the backscattering signal Sₙ(λ), the device being used in the same configuration: same source, same positioning in relation to the sample;
S_{ref}(λ) is the reference signal described in relation to the expression (1);
S_{source}(λ) is the signal representing the intensity of the illumination beam produced by the light source, described in relation to the expression (1);
t_{calib}(λ) is the time of acquisition of the signal S_{calib-n}(λ);
R_{calib-n}(λ) is the reflectance of the calibration sample, associated with a backscattering distance Dₙ. In this example,

$${R}_{calib \text{-} n} ( λ ) = \frac{{S}_{calib \text{-} n} ( λ ) - {S}_{ref} ( λ )}{{S}_{source} ( λ ) \times {t}_{calib}}$$

R_{calib-n}^{model}(λ) is an estimation of the reflectance R_{calib-n}(λ), this estimation being able to be produced by modeling the path of the light in the calibration sample, in particular by means of computation code of Monte-Carlo type or by an analytical model.

Thus, the calibration factor f_{n,pcalib}(λ) is a comparison between a modeled quantity of interest, in this case a reflectance, and the same quantity of interest measured by the device, on a calibration sample. This comparison generally takes the form of a ratio.

However, in the prior art, this calibration factor is obtained on a sample, whose optical properties p_{calib} are known, but are not necessarily representative of the optical samples of the sample being studied. Now, the inventors have determined that the value of this calibration factor can change, depending on the optical properties of the sample. For example, FIG. 5 represents different values of this calibration factor, obtained by using different calibration samples, at the wavelengths λ=470 nm, λ=607 nm and λ=741 nm. To perform these tests, water samples were formed, whose scattering and absorption properties are respectively modified by incorporation of intralipid and china ink. The calibration samples used comprise a concentration of intralipid % IL respectively equal to 1%, 2% and 3%, which confers on them different scattering properties, the absorption coefficient being equal to 0.4 cm⁻¹ to 600 nm⁻¹. The calibration factors represented were determined by considering a backscattering distance of 1.1 mm, the device 1 being placed at a distance from each calibration sample, the distance between the sample and the detection optical fibers ranging up to 20 cm.

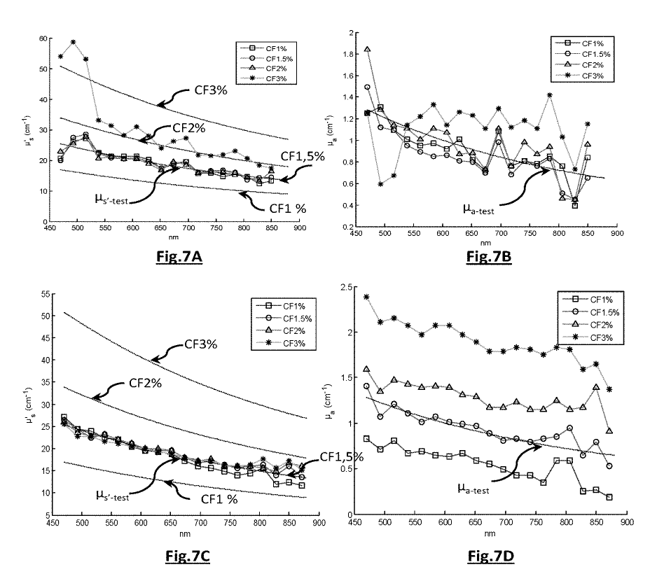

By using experimental tests, described in relation to FIGS. 7A to 7D, as a basis, the inventors estimated that it was preferable to use a calibration factor which is as representative as possible of the optical properties of the samples studied. Now, in the first iteration, these properties are not known. Also, in the first iteration (i=1), an initial calibration factor is used, denoted fₙⁱ⁼¹(λ) that is determined arbitrarily, for example by using an a priori as to the optical properties of the sample studied as a basis.

6^{th} step 160: for at least one wavelength λ and by considering at least as many different backscattering distances Dₙ as there are optical properties to be estimated, determination of the optical properties (p) exhibiting the least difference between the reflectance Rₙ(λ), determined in the preceding step, at the wavelength λ, and a modeled reflectance R_{n,p}^{model}(λ), this reflectance being modeled by considering a plurality of values of said optical properties p, at said backscattering distance Dₙ. This determination can be made by the minimization of a root mean square deviation, and for example according to the expression:

p=argminₚ(Σₙ₌₁^{N}(R_{n,p}^{model}(λ)−Rₙ(λ))²) (3)
N denotes the number of backscattering distances taken into account,
R_{n,p}^{model} is a reflectance modeled, at the backscattering distance Dₙ, by taking into account predetermined values of at least one optical property p. The parameter p can correspond to an optical property, or a set of optical properties.

In this example, the optical properties sought are μₐ(λ) and μ′ₛ(λ). Thus, the pair μₐ(λ), μ′ₛ(λ) sought is that exhibiting the least deviation between the measured reflectance Rₙ (λ), at the wavelength (λ), and a modeled reflectance R_{n,μa,μs′}^{model}(λ) for different values of μₐ(λ) and of μ′ₛ(λ), at said backscattering distance Dₙ. This determination can be made according to the expression

(μₐ(λ),μ′ₛ(λ))=argmin_{(μ}_{ₐ}_{(λ),μ′}_{ₛ}_{(λ))}(Σₙ₌₁^{N}(R_{n,μa,μs′}^{model}(λ)−Rₙ(λ))²) (3′),

R_{n,μa,μs′}^{model}(λ) denoting a reflectance modeled, at the backscattering distance Dₙ, by considering different values of μₐ and μₛ′.

Reflectance values modeled R_{n,μa,μs′}^{model}(λ) are obtained, for a plurality of pairs of values μₐ, μₛ′ during a parameterization phase, by numerical simulation implementing a method of Monte-Carlo type or by an analytical model. An analytical model can be used, preferably, only beyond a certain backscattering distance.

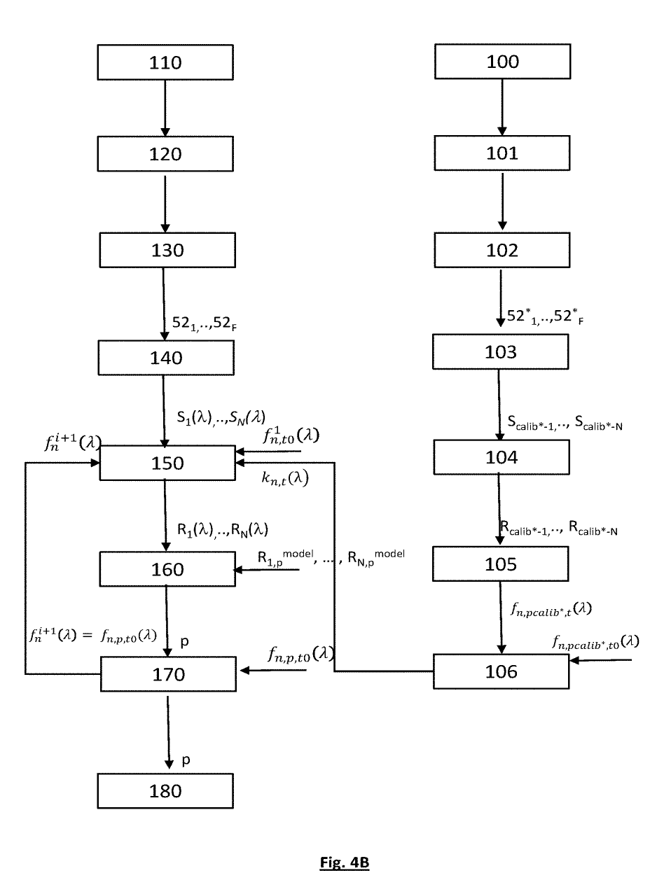

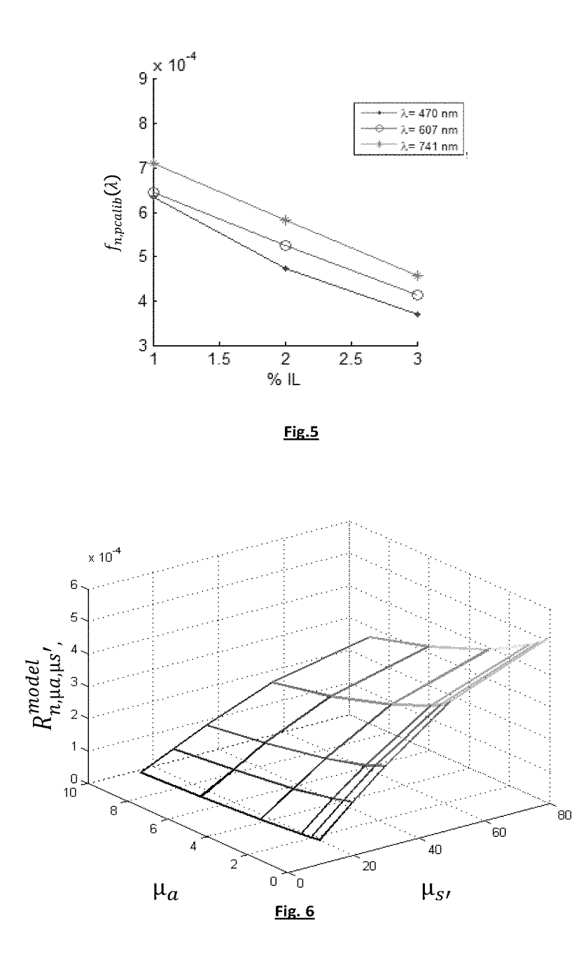

For a given backscattering distance Dₙ, it is possible to establish a plurality of reflectances R_{n,μa,μs′}^{model}(λ) modeled as a function of μₐ and of μₛ′. FIG. 6 gives an example of representation of such modeled reflectances, by considering a backscattering distance Dₙ, equal to 700 μm and by taking into account values of the absorption coefficient lying between 0 and 10 cm⁻¹, as well as values of the reduced scattering coefficient lying between 0 and 80 cm⁻¹. The steps 150 and 160 are implemented by the processor 48, previously programmed for this purpose, and for which the input data are the measurements of the backscattering signals Sₙ(λ) produced by the photodetector 40. Each calibration factor, as well as each value R_{n,p}^{model}(λ), can be stored in a memory, for example the memory 49, linked to the processor 48.

7^{th} step 170: updating of the calibration factor.

The implementation of this step assumes that different calibration factors f_{n,p}(λ) corresponding to calibration samples of known optical properties p, at a backscattering distance Dₙ, and at a wavelength λ, have been previously determined.

Generally, the notation f_{n,p}(λ) corresponds to a calibration factor corresponding to the optical properties p, at the backscattering distance Dₙ, for the wavelength λ. This calibration factor can be obtained using a measurement on a calibration sample, in which case it can also be denoted f_{n,calibp}(λ) the index calibp referring to the calibration sample of optical properties p. It can also be determined by interpolation calculation, as described herein below.

These different calibration factors can be obtained experimentally, by using calibration samples of known optical properties p, as described in relation to FIG. 5 or the equation (2). When several experimental measurements have been performed, it is possible to determine interpolated calibration factors between two calibration factors f_{n,p}(λ), f_{n,p′}(λ) corresponding respectively to samples of optical properties p and p′. The interpolation can be a linear interpolation.

It is then possible to have a library of calibration factors f_{n,p}(λ) corresponding to different backscattering distances Dₙ, to different optical properties p and to different wavelengths λ. These calibration factors are stored in a memory, for example the memory 49 linked to the processor 48. The inventors estimate that it is sufficient, between two iterations, for the calibration factors to be updated as a function of a scattering property of the sample, an update as a function of an absorption property being able to be omitted.

The step 170 consists in updating the calibration factor implemented in the method, by replacing each calibration factor fₙⁱ(λ), associated with a backscattering distance Dₙ in the current iteration i by a calibration factor corresponding to the optical properties p determined in the step 160, or by a calibration factor associated with an optical property that is as close as possible to the optical property p determined in the preceding step 160. Also, in the step 170, fₙⁱ⁺¹(λ)=f_{n,p}(λ), the parameter p being the optical parameter determined in the step 160. This calibration factor fₙⁱ⁺¹(λ) is then used in the step 150 of the next iteration i+1.

The iterative process is stopped after a predetermined number of iterations, or when the deviation between optical properties pⁱ, pⁱ⁺¹ determined during the step 160 of two successive iterations i and i+1, is below a predetermined threshold. The method then goes on to the step 180 of exiting the algorithm.

FIG. 4B represents a variant of this method, in which the steps 110 to 180 are similar to those explained in relation to FIG. 4A. However, prior to the implementation of this method, the device 1 is placed facing a calibration sample whose optical properties p_{calib} are known. In effect, the inventors have found that a calibration factor f_{n,p}(λ) is not stable in time, and that is because of the evolution of the properties of the components that make up the illumination line and the detection line. That can stem from a normal evolution of these components, for example the wear of an optical fiber, or the aging of the source, or even a slight displacement of the optical system. Because of this, a calibration factor f_{n,p,t0}(λ) determined at an instance t₀ may be different from a calibration factor f_{n,p,t}(λ) determined at an instant t, and all the more so when the time interval ΔT=t−t₀ is significant. In order to take account of this drift, the inventors have implemented a refreshing of the calibration factors f_{n,p,t0}(λ) determined at an instant t₀ and stored in memory. This is the object of the steps 100 to 106.

The steps 100, 101, 102 and 103 are respectively similar to the steps 110, 120, 130 and 140, the only difference being that the sample analyzed is the calibration sample. The detection optical fibers 22 collect a plurality of backscattered radiations 52₁* . . . 52_{F}*, the exponent * denoting the fact that a calibration sample is used. The photodetector 40 then forms as many backscattering signals S_{calib-1}(λ) . . . S_{calib-N}(λ) as there are different backscattering distances D₁ . . . D_{N}.

As indicated in relation to the equation (2), the step 104 allows a reflectance R_{calib-n}(λ) to be obtained, at each backscattering distance Dₙ, and for each wavelength λ considered. In the step 105, a calibration factor f_{n,pcalib*,t} (λ) is determined that corresponds to the calibration sample, according to the equation 2.

In the step 106, a refresh factor k_{n,t}(λ) is determined, associated with a backscattering distance Dₙ and with a wavelength λ, k_{n,t}(λ) being such that:

$${k}_{n , t} ( λ ) == \frac{{f}_{n , {pcalib}^{*} , t} ( λ )}{{f}_{n , {pcalib}^{*} , t 0} ( λ )} \qquad ( 4 )$$

f_{n,pcalib*,t}(λ) denoting the calibration factor, at the wavelength λ, produced at the current instant (instant t), on a calibration sample of known properties P_{calib}*, and corresponding to the backscattering distance Dₙ,
f_{n,pcalib*,t0}(λ) denoting the calibration factor, at the wavelength λ, produced at an instant t₀, prior to the current instant, on the same calibration sample, of optical properties p_{calib}*, and corresponding to the backscattering distance Dₙ. By combining the equations (4) and (2), the following is obtained:

$${k}_{n , t} ( λ ) == \frac{{f}_{n , {pcalib}^{*} , t} ( λ )}{{f}_{n , {pcalib}^{*} , t 0} ( λ )} = \frac{\frac{{S}_{{calib}^{*} \text{-} n , t 0} ( λ ) - {S}_{ref , t 0 ( λ )}}{{S}_{source , t 0} ( λ )} \times {t}_{{calib}^{*} , t}}{\frac{{S}_{{calib}^{*} \text{-} n , t} ( λ ) - {S}_{ref , t ( λ )}}{{S}_{source , t} ( λ )} \times {t}_{{calib}^{*} , t 0}} \qquad ( {4}^{′} )$$

The indices t and t₀ refer respectively to the measurement instants t and t₀. The exponent * represents a measurement performed on a calibration sample used to determine the refresh factor. The refresh factor k_{n,t}(λ) is essentially governed by the evolution of the backscattered signals S_{calib*-n,t0}(λ) and S_{calib*-n,t}(λ).

Also, more generally, the refresh factor k_{n,t}(λ) is determined by comparing:
a backscattering signal S_{calib*-n,t}(λ), representing a backscattered radiation emanating from the surface of a calibration sample, at a backscattering distance (Dₙ) from an illumination zone of said calibration sample, the latter being illuminated by said light beam (20);
and a backscattering signal S_{calib*-n,t0}(λ), measured, in the same conditions, at an instant t₀ prior to the instant t.

The calibration sample used for the determination of the refresh factor, according to the equations (4) and (4′), can be any calibration sample. Preferably, it is a calibration sample that can easily be transported, whose optical properties are particularly stable, in particular between the instants t and t₀. It can for example be a sample produced using a solid resin, whose optical absorption and scattering properties are respectively adjusted by the addition of china ink and of scattering particles of titanium oxide (TiO₂).

The inventors have estimated that such a refresh factor can be applied to all the calibration factors previously computed, whether they are derived from other calibration samples, less stable or less transportable, or from interpolation computations. Thus, each calibration factor f_{n,p,t0}(λ), after having been determined at an instant t₀, prior to the instant t, and stored in the memory 49, can be simply refreshed by the update formula:

f_{n,p,t}(λ)=k_{n,t}(λ)×f_{n,p,t0}(λ) (5)

in which:
f_{n,p,t}(λ) denotes the calibration factor, corresponding to the optical properties p, and to the backscattering distance D, refreshed at the current instant t;
f_{n,p,t0}(λ) denotes the calibration factor, corresponding to the optical properties p, and to the backscattering distance Dₙ, determined at the instant t₀ and stored in the memory 49.

Note that a single calibration sample can suffice to determine the refresh factor k_{n,t}(λ), and allow the refreshing of all of the calibration factors f_{n,p,t0}(λ) established previously, corresponding to the backscattering distance Dₙ with which the refresh factor is associated, and stored in the memory 49.

The refresh factor k_{n,t}(λ) is then implemented, in the form of a multiplying term, in the step 150 of the determination quantity of interest Rₙ(λ) from the backscattering signal Sₙ(λ). The expression (1) can then be replaced by the expression (1′):

$${R}_{n} ( λ ) = \frac{{S}_{n} ( λ ) - {S}_{ref} ( λ )}{{S}_{source} ( λ ) \times t} \times {f}_{n}^{i} ( λ ) \times {k}_{n , t} ( λ ) \qquad ( {1}^{′} )$$

Experimental tests implementing the device represented in FIGS. 1 and 2 will now be described, in a remote configuration or in a contact configuration. The device is arranged facing test samples comprising a water base, and whose optical absorption and scattering properties are adjusted respectively by the addition of china ink and of intralipid.

During these tests, the optical properties p sought are the absorption coefficient μₐ and the reduced scattering coefficient μ_{s′}.

FIGS. 7A and 7B represent respective estimations of the reduced scattering coefficient and of the absorption coefficient as a function of the wavelength, in tests performed in contact on a test sample whose optical properties are known: its absorption coefficient is equal to 1 cm⁻¹ at 600 nm, whereas its reduced scattering coefficient, equivalent to a concentration of 1.5% of intralipid, rises to 22 cm⁻¹ at 600 nm.

In FIG. 7A, each dotted-line curve corresponds to the theoretical value of the reduced scattering coefficient of 4 calibration samples, as a function of the wavelength. Each calibration sample has a same absorption coefficient μₐ=0.4 cm⁻¹ at 600 nm and a concentration of intralipid respectively equal to 1%, 1.5%, 2% and 3%. Their reduced scattering coefficients μₛ′, at 600 nm, are respectively 13.5 cm⁻¹, 20.3 cm⁻¹, 27 cm⁻¹ and 40.6 cm⁻¹. These four calibration samples are respectively denoted “CF1%”, “CF1.5%”, “CF2%” and “CF3%”. These calibration samples are used to establish a calibration factor f_{n,p}(λ), associated with the optical properties p of each sample.

The test sample was subjected to an illumination by the light source 10, during which the backscattered signal S₂(λ) . . . S₆(λ) was detected, corresponding respectively to 5 backscattering distances D₂ . . . D₆. The wavelength spectrum of each of these detected signals was produced, in a spectral band lying between 470 nm and 880 nm. The reflectance of the test sample R₂(λ) . . . R₆(λ), at the different backscattering distances, was determined by using the expression (1).

At each wavelength λ, each calibration factor f_{n,p}(A), associated with each calibration sample, was successively considered so as to calculate 4 measurements of the reflectance. The reduced scattering coefficient μₛ′(λ) (see solid-line curve of FIG. 7A) and the absorption coefficient μₐ(λ) (see solid-line curve of FIG. 7B) were then estimated, each estimation being respectively associated with the recognition of a calibration factor established using a calibration sample, as indicated in the key to these curves.

In FIG. 7A, the dotted-line curve denoted “μ_{s′-test}” corresponds to the reduced scattering coefficient μ_{s′}(λ) of the test sample. It represents the exact value of the reduced scattering coefficient as a function of the wavelength. The solid-line curves correspond to the estimations of this coefficient, at different wavelengths. It appears that the conclusion of a calibration factor based on the calibration sample CF3% culminates in an erroneous estimation of μ_{s′}(λ). The estimations using a calibration factor established with the other calibration samples (CF1.5%, CF1% and CF2%) are more in line with reality, the best estimation being obtained with the calibration factor established with the calibration sample CF1.5%. That confirms the basic hypothesis of this invention, whereby the optical properties of a sample are all the better estimated when they are calculated based on a calibration factor f_{n,p}(λ) representative of the optical properties of said sample.

In FIG. 7B, the dotted-line curve denoted “μₐ₋ₜₑₛₜ” corresponds to the absorption coefficient μₐ(λ) of the test sample. It represents the exact value of the absorption coefficient as a function of the wavelength. The solid-line curves correspond to estimations of this coefficient, at different wavelengths, each estimation being made by considering a calibration factor f_{n,p}(λ) determined respectively with each calibration sample. As in FIG. 7A, the estimations based on the sample CF3% lead to erroneous results, the best estimation being that taking account of the calibration sample CF1.5%.

FIGS. 7C and 7D respectively represent results similar to FIGS. 7A and 7B, the device used comprising an optical system 30, allowing it to be used at a distance from the sample. In this configuration, the distal end of the detection optical fibers is placed at 20 cm from the surface of the sample. It is observed that the inclusion of a calibration factor representative of the optical properties of the sample studied very significantly improves the estimation of the absorption coefficient. More specifically, it is noted that the inclusion of a calibration factor based on different optical properties of the sample studied leads to significant errors in the estimation of the absorption coefficient, as the curve CF3% of FIG. 7D shows.

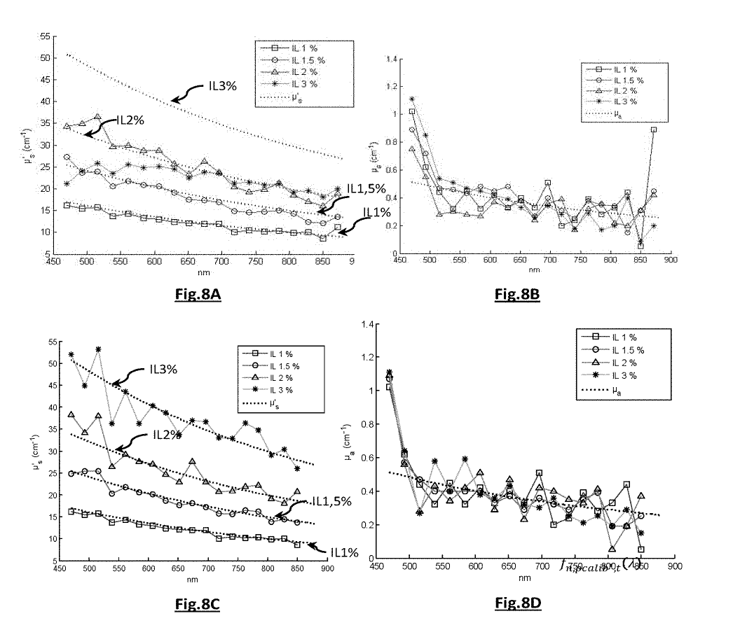

FIGS. 8A, 8B and 8C, 8D represent estimations of the optical properties (μₛ′(λ) and μₐ(λ)) respectively according to the prior art and by implementing the invention, the device being applied in contact with four test samples. The real values of the reduced scattering coefficient of each test sample are represented by dotted lines in FIGS. 8A and 8C. The real values of the absorption coefficient of each test sample are represented by dotted lines in FIGS. 8B and 8D. These 4 test samples, denoted IL1%, IL1.5%, IL2%, IL3% are respectively identical to the calibration samples CF1%, CF1.5%, CF2% and CF3% previously described. In each figure, the solid-line curves correspond to estimations of the coefficients μₛ′(λ) or μₐ(λ) of each test sample.

FIG. 8A represents estimations of the reduced scattering coefficient of each test sample. In this figure, for each estimation, the same calibration factor was used, established using the calibration sample CF1%. The reduced scattering coefficient is correctly estimated for the sample IL1%, since the method uses a calibration factor established with this same sample. The reduced scattering coefficient of the sample IL1.5% is also determined correctly. On the other hand, the reduced scattering coefficients of these samples IL2% and IL3% are not estimated with satisfactory accuracy.

FIG. 8C represents similar measurements, by implementing the algorithm previously described, with, in the first iteration, the use of a calibration factor established using the calibration sample IL1%. Contrary to the results obtained in FIG. 8A, the reduced scattering coefficient of each test sample was correctly estimated.

FIG. 8B represents estimations of the absorption coefficient of each test sample. In this figure, for each test sample, the same calibration factor was used, established using the calibration sample CF1%. FIG. 8D represents similar measurements, by implementing the algorithm previously described, with, in the first iteration, the use of a calibration factor established using the calibration sample CF1%. The accuracy of the estimation is satisfactory in both cases, but the implementation of the algorithm increases this accuracy.

For each of these figures, the square root of the mean square error was estimated, denoted E, normalized, estimated according to the expression:

$$ɛ = \sqrt{{{mean}_{λ} [ \frac{p ( λ ) -}{p ( λ )} ]}^{2}} \times 100$$

with:
p(λ)=real value of the optical property p at the wavelength λ, the optical property being either the reduced scattering coefficient μₛ′ or the absorption coefficient μₐ.
[symbol] =estimation of the optical property p at the wavelength λ, the optical property being either the reduced scattering coefficient μ_{s′} or the absorption coefficient μₐ.

The results corresponding to the different FIG. 8A (estimation of μₛ′ without implementation of the invention), 8B (estimation of μₐ without implementation of the invention), 8C (estimation of μₛ′ with implementation of the invention), and 8D (estimation of μₐ with implementation of the invention), are reported in table 1 below:

TABLE 1

| ε | | IL1% | IL1.5% | IL2% | IL3% |
|---|---|---|---|---|---|
| μa | FIG. 8B | 29.1% | 20.7% | 23.4% | 29.3% |
| | FIG. 8D | 29.1% | 17.5% | 31.4% | 26.5% |
| μ′s | FIG. 8A | 3.7% | 5.5% | 6.7% | 38.9% |
| | FIG. 8C | 3.7% | 3.7% | 7.1% | 6.7% |

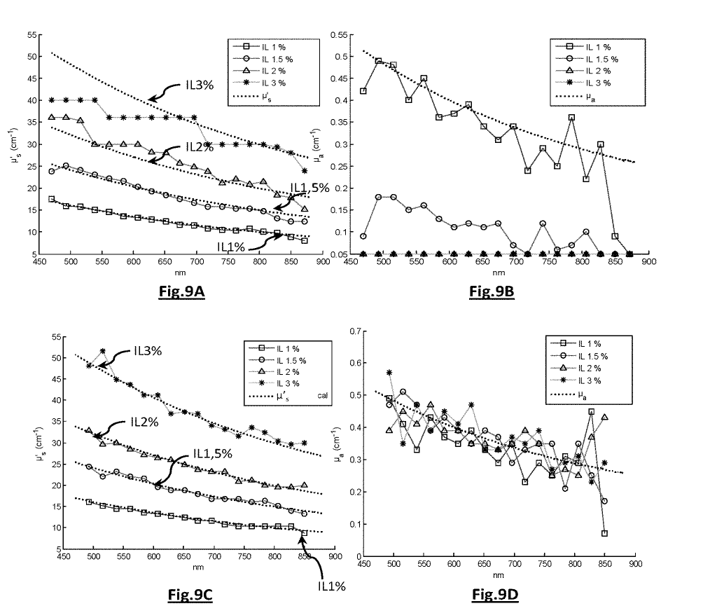

FIGS. 9A, 9B, 9C and 9D represent tests similar to those reported respectively reported in FIGS. 8A, 8B, 8C and 8D, the only difference being that the device is used according to a “remote” configuration, and by implementing an optical focusing system, the distance between the end of each detection fiber and the sample being 20 cm.

For each of these figures, the square root of the mean square error, ε, was also estimated, as previously defined. The results are reported in table 2 below.

TABLE 2

| ε | | IL1% | IL1.5% | IL2% | IL3% |
|---|---|---|---|---|---|
| μa | FIG. 9B | 13.9% | 71.8% | 86% | 86% |
| | FIG. 9D | 13.9% | 9.3% | 11.9% | 10.3% |
| μ′s | FIG. 9A | 1.9% | 3.5% | 6.8% | 8.3% |
| | FIG. 9C | 1.9% | 2.5% | 2.1% | 2.6% |

The implementation of an algorithm according to the invention makes it possible to significantly improve the accuracy of the estimations of optical properties of the sample.

Although the tests described were carried out by implementing a white light source and a spectrometric photodetector 40, configurations based on a monochromatic light source, or a plurality of light sources emitting in different spectral bands, and/or the detection of a backscattering signal using a non-spectrometric photodetector can be envisaged.

In particular, the white light source can be replaced by different light sources emitting in different spectral bands λ₁, λ₂ . . . λ_{L}. Thus, the illumination beam 20 can comprise, simultaneously or successively, different spectral bands λ₁, λ₂ . . . λ_{L}. The device can also comprise a light source, comprising a plurality of band pass optical fibers, that can be successively placed facing the source. In this way, the illumination beam 20 successively comprises different spectral bands λ₁, λ₂ . . . λ_{L}.

Generally, the light source, whatever it may be, can form, on the surface of the sample, an elementary illumination zone as previously defined. The recourse to optical fibers to form the illumination beam is not essential. A light source could be a laser source, or another light source, for example a light-emitting diode. The light source can be coupled to an optical forming system, allowing the formation of the light beam 20 and the projection thereof onto the surface of the sample in order to define the elementary illumination zone 18.

Similarly, the photodetector can be a photodiode, or a matrix photodetector of CCD or CMOS type. Each pixel of the photodetector is then coupled to an elementary detection zone either by the optical system 30, or by being placed in contact with the surface of the sample, or possibly via optical fibers. The use of such a photodetector makes it possible to obtain a large number of different backscattering distances. It should be preferred in the applications requiring a good spatial resolution. When the light source is capable of forming an illumination beam 20, successively, in different spectral bands λ₁, λ₂ . . . λ_{L}, such a photodetector can detect measure a backscattering signal Sₙ(λ), successively, in each of the spectral bands. Preferably, the optical property is then determined in each spectral band, independently of one another, by implementing the steps described above. As can be seen in relation to the examples described above, the width of a spectral band can be less than 10 nm, so as to have an accurate estimation of the evolution of the optical property considered as a function of the wavelength.

The number N of backscattering distances can also vary. Generally, this number should be greater than or equal to the number of optical properties to be determined.

The invention can be implemented to characterize the surface optical properties of a sample. When applied to the skin, it for example makes it possible to detect pathologies early, check the vascularization or the perfusion of an active principle. It can be applied to any application, of non-destructive inspection type, making it possible to estimate or track the evolution of an optical property in proximity to the surface of a sample. It can for example concern applications in the field of agro-foods, in order to check the quality or the composition of food products.

1-13. (canceled)

14. A method for determining an optical property of a sample, comprising:
i) illuminating a surface of the sample, using a light beam produced by a light source, to form, on the surface of the sample, an elementary illumination zone, corresponding to a part of the surface lit by the light beam;
ii) acquiring, using a photodetector, a backscattered signal, at a wavelength representative of a radiation backscattered, at the wavelength, by the sample at a backscattering distance, from the elementary illumination zone;
iii) selecting a calibration factor corresponding to the backscattering distance and to the wavelength;
iv) applying the calibration factor to the backscattered signal, to obtain a quantity of interest, associated with the backscattering distance;
v) determining at least one optical property of the sample, at the wavelength, using the quantity of interest;
vi) repeating the iv) to v), by updating the calibration factor, as a function of the determined optical property, until a stop criterion or a predetermined number of iterations is reached;
wherein at least one calibration factor is a calibration factor measured by effecting a ratio between:
an estimation of a quantity representative of a backscattered radiation emanating from a surface of a calibration sample, at the wavelength, to the backscattering distance from the elementary illumination zone of the calibration sample, when the calibration sample is illuminated by the light beam;
a measurement of the quantity, using a backscattered signal detected by the photodetector, at the wavelength, the calibration sample being illuminated by the light beam; and
wherein least one calibration factor is determined by interpolation from two measured calibration factors, at the wavelength, the measured calibration factors being previously obtained by using, respectively, two calibration samples whose optical properties are different.

15. The method of claim 14, wherein in the vi), the calibration factor is updated by a calibration factor determined as a function of the optical property defined in the v) preceding the vi).

16. The method of claim 15, wherein the optical property considered for the updating of the calibration factor is a scattering property.

17. The method of claim 16, wherein the optical property is chosen from:
a scattering coefficient, or a reduced scattering coefficient.

18. The method of claim 14, wherein the iv) comprises application of a refresh factor, determined by:
measuring, at an instant t, a backscattered signal, representing a backscattered radiation emanating from the surface of a calibration sample, at the backscattering distance from the elementary illumination zone of the calibration sample, the calibration sample being illuminated by the light beam;
comparing the backscattered signal measured at the instant t to a signal measured, in same conditions, at a previous instant t0 prior to the instant t,
such that each calibration factor, corresponding to the backscattering distance, is refreshed by the refresh factor.

19. The method of claim 14, wherein, in the v), the determination of the optical property comprises a comparison between:
a quantity of interest;
a plurality of estimations of quantity of interest, each estimation being performed by considering a predetermined value of the optical property.

20. The method of claim 14, wherein each backscattering signal is acquired at a plurality of wavelengths, such that the quantity of interest and the calibration factor are spectral functions, defined over the plurality of wavelengths.

21. The method of claim 14, wherein the quantity of interest, associated with a backscattering distance, is obtained by application of a ratio between the intensity of a backscattered signal, corresponding to the backscattering distance, by the intensity of the light beam, measured by the photodetector, in which case the quantity of interest is a reflectance.

22. The method of claim 14, wherein, in the v), different values of the quantity of interest are considered, each value corresponding to a different backscattering distance.

23. The method of claim 14, wherein the sample studied is a human, animal, or plant tissue, or a food product.

24. A non-transitory computer readable information storage medium, comprising instructions for execution of a method as claimed in claim 14, these instructions being configured to be executed by a processor.

25. A device for measuring an optical signal produced by a sample comprising:
a light source configured to emit a light beam toward a surface of the sample, to form, on the surface, an elementary illumination zone;
a photodetector, configured to acquire a backscattered signal, representative of a radiation backscattered by the sample at a backscattering distance, from the elementary illumination zone;
a processor, capable of implementing the iii) to vi) of the method of claim 14.

26. The device of claim 25, further comprising an optical system, configured to ensure an optical coupling between the photodetector and an elementary detection zone located on the surface of the sample, from which the backscattered radiation emanates.
